(19) United States
(12) Patent Application Publication
(10) Pub. No.: US 2017/0174937 A1
(43) Pub. Date: Jun. 22, 2017

(54) Electrically Conductive Polyamide-imide Mixture for the Purpose of Creating Electrical Circuits.

(71) Applicants: Ryan David Allmandinger, San Diego, CA (US); Donald David Allmandinger, Grants Pass, OR (US)

(72) Inventors: Ryan David Allmandinger, San Diego, CA (US); Donald David Allmandinger, Grants Pass, OR (US)

(21) Appl. No.: 14/975,836

(22) Filed: Dec. 20, 2015

(51) Int. Cl. C09D 179/08; C09D 7/12; C09D 5/24; H01C 10/00

(52) U.S. Cl. CPC C09D 179/08; H01C 10/00; C09D 7/1216; C09D 5/24; C08K 2003/0806

(57) ABSTRACT

A conductive thermoplastic utilizing modern plastics and processes for the purpose of improving modern circuitry is provided. By mixing polyamide-imide with a conductive material (such as, but not limited to, carbon, silver, copper, or gold) an electrically conductive mixture is created that can be printed into circuitry as well as other devices. This method of circuit printing is strong and resistant to environmental forces.

This application claims priority under 35 U.S.C. §120 as a continuation-in-part of U.S. patent application Ser. No. 13/956,380, filed Oct. 11, 2013, entitled “Electrically Conductive Polyamide-imide mixture for the Purpose of Creating Electrical Circuits.”

### FIELD OF THE INVENTION

This invention generally relates to conductive polymer compositions. In particular, the invention is directed to such compositions, which are suitable for making position sensing elements and other devices and apparatus.

### BACKGROUND OF THE INVENTION

In the jargon of the conductive plastic potentiometer industry, the component that receives the electrical input signals and creates the electrical output is called the “potentiometer element”, or most often “element”. The two most common methods to produce conductive plastic potentiometer elements are called “Raised Track” and “Compression Co-molded”. An explanation of each follows:
1. The Raised Track method involves printing an electrically conductive ink onto a supporting substrate, then drying or curing the ink to complete the process. The track is above (on top of) the substrate and as a result, there is a step, or raised edge around the printed track. This raised edge causes accelerated wear on the rotating mating contact, and on the track edge. Also, because the ink cure temperatures are usually higher than the substrate can withstand, the inks are seldom cured to maximum strength, thereby reducing the usable life of the product. Also, the ink surface created when using this method is not smooth, which creates an erratic electrical signal output. This process also allows the potential for track to substrate delamination (separation).
2. The Compression Co-molded method involves printing a conductive ink track onto a packed powder substrate, then subjecting the substrate to a high pressure/high temperature molding process. As the ink is heated in the mold, it melts, and the applied pressure then distorts the shape of the track. Also, the porosity of the substrate material absorbs the some of the liquefied ink creating an inconsistent track density. The distorted track creates inaccuracies in the finished product.

Therefore, there remains a need to overcome one or more of the limitations in the above-described, existing art. The discussion of the background to the invention included herein is included to explain the context of the invention. This is not to be taken as an admission that any of the material referred to was published, known or part of the common general knowledge as at the priority date of the claims.

### DETAILED DESCRIPTION OF THE PREFERRED EMBODIMENTS

In the following description, for the purposes of explanation, numerous specific details are set forth in order to provide a thorough understanding of the electrically conductive polyamide-imide mixture that embodies principals of the present invention. It will be apparent, however, to one skilled in the art that the electrically conductive polyamide-imide mixture may be practiced without some of these specific details. Throughout this description, the embodiments and examples shown should be considered as exemplars, rather than as limitations on the electrically conductive polyamide-imide mixture. That is, the following description provides examples. However, these examples should not be construed in a limiting sense as they are merely intended to provide examples of the electrically conductive polyamide-imide mixture rather than to provide an exhaustive list of all possible implementations of the electrically conductive polyamide-imide mixture.

This invention describes the materials and processes used to create and deposit the conductive polyamide-imide mixture onto a reusable surface, such as a steel disk, that is then used in a transfer-injection molding process for the purpose of producing potentiometers, position sensors, rheostats, variable resistors, and other suitable electrical components.

This process is superior to all other processes most notably because of how this invention creates a hard, smooth and accurate surface on the element, and bonds the conductive track to the substrate without raised edges or distortion.

The conductive polyamide-imide mixture is a blend of polyamide-imide powder and conductors such as carbon powder, carbon black, graphite, silver, gold, platinum, copper, nickel and other powdered conductors. The blend ratio of polyamide-imide to conductors is dependent upon the application and the materials used.

The transfer-injection molding process involves: depositing the conductive polyamide-imide mixture onto the reusable surface, placing the surface into a molding cavity and filling the cavity with the same thermoplastic material contained in the conductive polyamide-imide mixture. The conductive polyamide-imide mixture and the filler material are molded together at 700° +F., becoming a homogeneous material. The molded piece is then separated from the reusable surface. The molded plastic component is called a “Co-molded element” (the reusable surface is reused for additional element production).

Some of the advantages of this process, as compared to traditional methods, include:
1. The molding process cures the conductive polyamide-imide mixture into the body of the component to maximize hardness and lifespan capable of withstanding significant thermal changes, physical shock, and wear (greater than one-hundred million cycles).
2. The surface of the track is extremely smooth, creating a very consistent and distortion free electrical output signal.
3. The edges of the track are flush with the substrate, allowing maximum contact-wiper life and minimizing sliding resistance.
4. The conductor-to-substrate interface is a homogeneous bond thus eliminating the possibility of material delamination (separation).
5. The polyamide-imide material is stronger than most of the other substrates available on the market.
6. The excess material of the molding process can be recycled and reused, minimizing harmful environmental impact and waste.

It is to be noticed that the term “comprising”, used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B.

Thus, it is seen that electrically conductive polyamide-imide mixture is provided. One skilled in the art will appreciate that the present invention can be practiced by other than the above-described embodiments, which are presented in this description for purposes of illustration and not of limitation. The specification is not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. An electric circuit component, comprising:
an electrically conductive polyamide-imide pathway transfer-injection molded into a polyamide-imide resin body.

2. The electric circuit of claim 1, where the electrically conductive polyamide-imide pathway comprises a multiplicity of electrically conductive particles selected from a group consisting of:
a carbon powder, a carbon black, a graphite, a silver, a gold, a platinum, a copper, a nickel and a combination of two or more thereof.

3. The electric circuit of claim 1, where the electrically conductive polyamide-imide pathway comprising an electrically conductive powder material and a polyamide-imide powder, is applied to a reusable surface, which is then inserted into an injection mold for the purpose of over-molding with a polyamide-imide resin in a process known as transfer-injection molding.

4. The electric circuit of claim 1, where the electric circuit is designed to function as a component selected from a group consisting of: a potentiometer, a position sensor, a rheostat, and a variable resistor.
